(19) United States
(12) Patent Application Publication
(10) Pub. No.: US 2014/0316639 A1
(43) Pub. Date: Oct. 23, 2014

(54) DATA CONVERSION APPARATUS AND METHOD OF USING A CELL PHONE TO UPDATE FAULT CODE DATA AND MAINTAIN VEHICLES USING ON-BOARD DIAGNOSTIC SYSTEMS

(71) Applicant: Calvin Ray Braswell, Abilene, TX (US)

(72) Inventor: Calvin Ray Braswell, Abilene, TX (US)

(21) Appl. No.: 13/866,000

(22) Filed: Apr. 18, 2013

(51) Int. Cl. G07C 5/00

(52) U.S. Cl. CPC G07C 5/008
USPC 701/29.6; 701/31.5

(57) ABSTRACT

An apparatus for obtaining diagnostic codes from vehicles with on-board diagnostic systems, using a cell phone as the code reader, and employing a signal converter between the cell phone and vehicle to allow communication between the cell phone and the vehicle's on-board diagnostic system, and allowing the cell phone to access remote databases and obtain the most current proper parameters to aid a user in troubleshooting vehicle problems and suggesting corrective action.

### TECHNICAL FIELD OF THE INVENTION

The present invention relates to a system and method of diagnosing a vehicle which employs a cell phone or other wireless Internet interface establishing an electronic communications link with remote databases for real-time correlation of diagnostic fault codes and vehicle maintenance.

### BACKGROUND OF THE INVENTION

Modern automotive vehicles include on-board diagnostic (OBD) computer control systems comprising computer processers, sensors, switches, and actuators. These components send information to the on-board computer regarding operating conditions, e.g., engine temperature, engine speed, fuel/air ratios. The on-board computer scans for any problems by comparing sensor readings with acceptable specifications in a look-up table stored within the on-board computer memory.

If the on-board computer detects an operational characteristic that is not within the proper range, the computer stores the information as a parameter identification number in its memory for later retrieval. Mechanics typically refer to these codes as “diagnostic fault code” or “diagnostic trouble codes” (DTC), recognized as useful codes that identify a particular problem area and assist owners and mechanics to efficiently keep a vehicle in proper operating condition.

Starting in the 1980s, many manufacturers began adopting industry standard computer codes and protocols that allow for non-proprietary code readers. The most popular protocols have been developed by the Society of Automotive Engineers (SAE J1850 and J1939, for example) and the International Organization for Standardization (ISO 11898, ISO 15765, ISO 9141-2, ISO 14230, ISO 15031 and ISO 15765), all of which are generally accepted under the OBD-II interface and incorporated herein. The connector is defined in the SAE J1962 standard. The United States has required vehicle compliance with OBD-II since 1996.

Though these protocols vary in approach considerably, with pulse-width modulation, variable pulse modulation, and message lengths from 12 to 255 bytes of data, OBD II defines the same single SAE-defined physical connector, with code readers typically made to employ a particular protocol based on which pins are present in the vehicle connector.

Non-mechanics have been using hand-held code readers to handle less complex maintenance of automobiles, looking up the DTCs reported by the vehicle, and attempting to save money by avoiding a costly visit to a mechanic and repairing their own car. However, automotive shops have to continuously update their code listing to include the latest cars and changes in the programming and databases as necessary. Lay mechanics do not have access to these changes, or struggle to update their reader's database.

Moreover, shade-tree mechanics use code readers infrequently, making them subject to easy misplacement, dead batteries, difficulties of use due to loss of manuals, and a need to update the reader using an unfamiliar process. Too often, even when a user obtains the code without difficulty, the meaning of the code is cryptic, resulting in frustrated users combing automotive forums searching for assistance in interpretation and the “next step” in fixing their vehicle.

Mechanics, both professional and lay men, have need of a system by which they can keep their code information up to date automatically, obtain easy interpretation of the codes obtained, and suggested courses of action based on those codes.

### SUMMARY OF THE INVENTION

The present disclosure provides an apparatus and method of obtaining diagnostic trouble codes (DTCs) from vehicles, interpreting their meaning, and suggesting courses of action for the user to repair their vehicle.

The apparatus comprises a connection cord which plugs into a vehicle's J1962 connector on one end to receive diagnostic trouble codes in an ODB-II accepted protocol, and on the other end plugs into an Internet-connected processor, typically a cell phone or Wifi-connected hand-held computer, that is programmed to take the output of the connection cord, sends an automated query through the Internet to check a central database for an interpretation of the trouble codes, and provide maintenance advice to the user.

Some of the acceptable ODB-II protocols use 5V power and data structure that a cell phone could theoretically accept given proper programming, but most would require a signal converter between the vehicle and cell phone to transform the ODB-II protocol data stream to a traditional USB for phone input. A connection conversion may also be necessary, as physical connection approaches change over time, i.e., USB has migrated from mini-USB to micro-USB as the dominant connector in cell phones in the last few years.

Though the typical Internet-accessible device employed in this application is a cell phone, Wifi-connected iPads and other similar devices could be used.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 depicts a symbolic relational block diagram representing the physical components of the apparatus in operation.

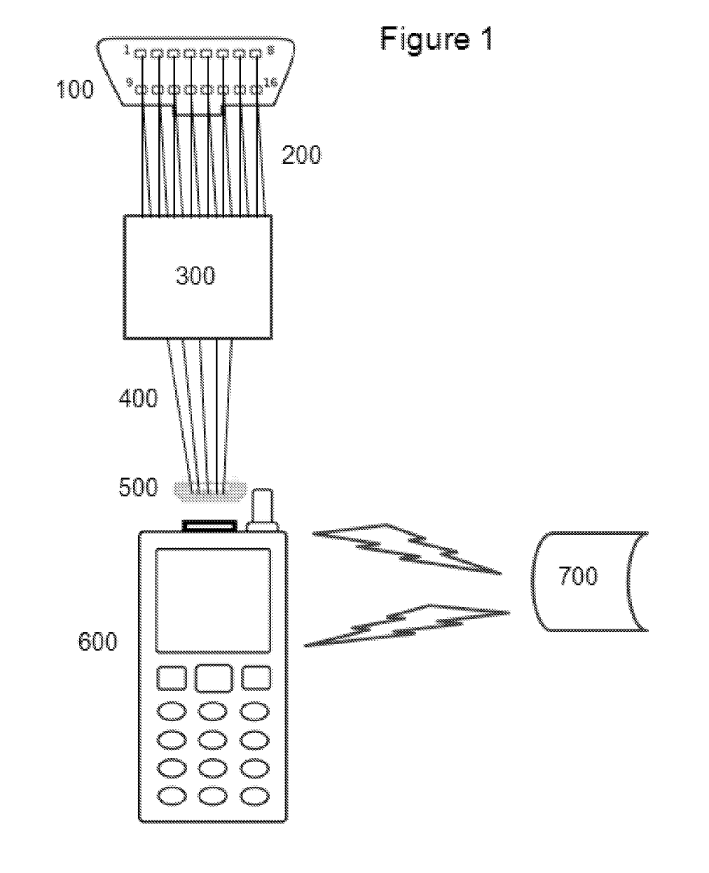

FIG. 2 depicts a flow chart diagramming the method of use of the apparatus.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

This invention assumes that the vehicle to be tested possesses an on-board diagnostic system, and therefore has a vehicle-side J1962 connector, typically located on the driver's side, under the dash, and the vehicle's system is properly functioning. The federal government has required vehicles to be equipped with a diagnostic system since 1996.

During operation, a Vehicle Cord 200 is connected between the vehicle's SAE J1962 diagnostic connection port and the Signal Converter 300; communication between the port and Signal Converter 300 is performed in accordance with the ODB-II standard. The Signal Converter 300 is connected to the Processor 600 (usually a cell phone) by a Processor Cord 400; these two components use the USB protocol for communications between them.

In typical use, the Processor 600 is a cell phone or other Internet-capable device, and the Application 150 is a program loaded into the Processor 600 which directs the gathering and analysis of collected data, and communicates the results through an LCD screen or alternatively, responsive audible output.

When the vehicle is in operation, its on-board computer continuously communicates with the ODB-II system, providing signal measurements when prompted by a code reader. In this application, however, a Signal Converter 300 is necessary to bridge the communications gap between the data structure of the vehicle's ODB-II system and the Processor 600 because different types of ODB-II protocols use different voltage levels and data message lengths. The Signal Converter 300, sitting in line between the Data Input Cord 200 and the Data Output Cord 400, converts the data requests coming through the Data Request Cord 200 from the Processor 600 while running the Application 150, and also converts the responses to those requests to USB protocol for the Processor's use. The Processor 600 typically provides the interface to a user through its LCD screen or by audible communications.

The Signal Converter 300 determines what protocol is being used by the vehicle and automatically adjusts its operation so that it can translate ODB-II signals to the serial bus communication protocol of Processor 600 (typically a cell phone). Many commercial code readers include a similar function, and details regarding the construction and data conversion are not necessary in this disclosure. It is expected that any person having skill in code readers can build a suitable embodiment of the Signal Converter 300 without undue experimentation.

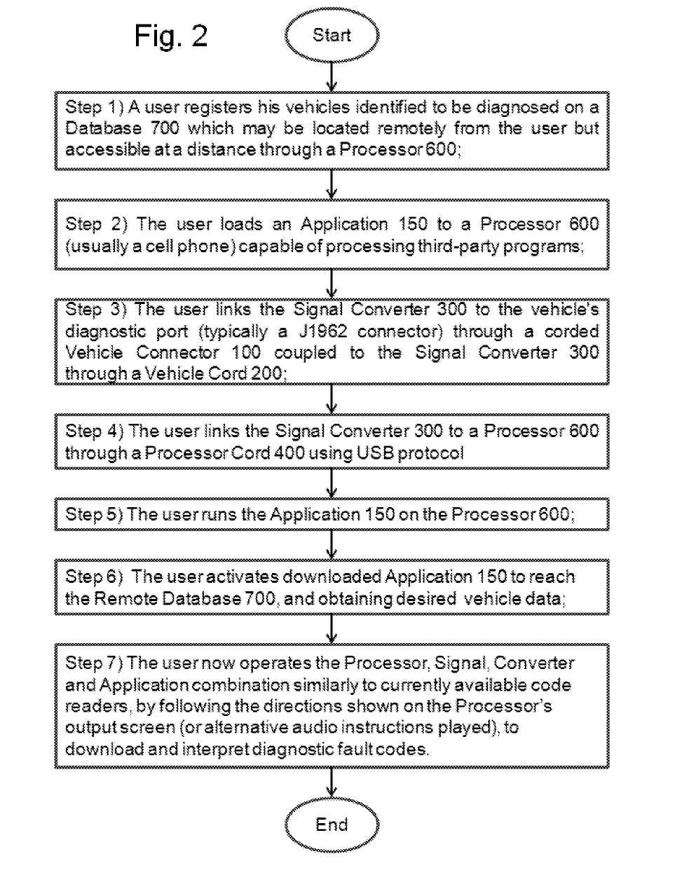

FIG. 2 depicts the method of use, the steps for which comprise:
1) registering a user and his vehicles with a Remote Database 600, located remotely from the user but electronically accessible at a distance;
2) loading an Application 150 on a Processor 600 (usually a cell phone) capable of processing third-party programs, such as cell phones using the iPhone or Linix-based Android operating systems;
3) linking the Signal Converter 300 to the vehicle's diagnostic port (typically a J1962 connector) through a corded Vehicle Connector 100 coupled to the Signal Converter 300 through a Vehicle Cord 200;
4) linking the Signal Converter 300 to a Processor 600 (typically this connection uses a micro-USB form factor connector) through a Processor Cord 400 using USB protocol.
5) running the downloaded Application 150 on the Processor 600;
6) activating the downloaded Application 150 to reach the Remote Database 700, and obtaining specific information for the target vehicle to be diagnosed;
7) following the directions provided on the cell phone to test and download all DTCs, just as users do with current code readers available in the art;
8) receiving maintenance instructions, information and suggested maintenance actions from the Application 150 obtained by the Remote Database 700.

This system may include a subscription service in which a user can register, provide financial information to allow automatic updating when users use the Processor 600 to activate the Application 150. This allows users to pay only for updates only when the update will be immediately used, and only the vehicles relevant to a user.

One should note that several of the steps need not be performed in the order stated, which is only one possible order. A user can connect the J1962 Connector 100 to the vehicle diagnosis port, then to a cell phone (Processor 600), use the Internet access of the phone to register as a user of the Remote Database 700, download the application 150, and then begin the diagnostic process.

The Remote Database 700 sits on a server that may be reached by use of an installed Application 150. The Application may be downloaded, installed, and then operated as any other application installed on a cell phone. When activated, the Processor 600 loads the Application 150, which commands the Processor 600 to send queries through the USB Processor Connector 500, Processor Cord 400, to the Signal Converter 300, which converts the USB-protocol query to a command commensurate to the flavor of the ODB-II protocol that the vehicle employs. Details regarding this process are not relevant to the claims made in this application, but the applicants assert that any person having ordinary skill in the art of cell phone applications and ODB-II protocols.

The Processor 600 is typically going to be a programmable mobile phone with Internet capability, but any number of similarly able electronic devices could be used for this component, including iPads, laptops, or even desktop computers sitting in a mechanic's shop with a USB cable long enough to reach the ODD-II port under the vehicle dash.

The embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

What is claimed is:

1) An apparatus to assist in vehicle maintenance, comprising:
a) a first electrical connector suitable to plug into a vehicle's on-board diagnostic computer system;
b) a first electrical cord connecting the first electrical connector to an enclosed signal converter;
c) a second electrical cord linking the enclosed signal converter to a second electrical connector capable of plugging into a USB input of a computer with Internet access;
d) the enclosed signal converter includes electronic circuitry and firmware, and is constructed so that when the first connector is plugged into a powered on-board diagnostic computer system, the signal converter configures its communication protocol through the first connector to match that of the vehicle's diagnostic system to which it is attached, identifies the vehicle by reading its VIN from the diagnostic system, and based on queries received through the second USB connector, delivers information and operational measurements to the computer as commanded by signals received through the USB connection; and,
e) a software application that can be installed on a cell phone or other microprocessor-equipped computer that, when operated by a user, reads diagnostic codes and optionally prescribes solutions addressing vehicle fault conditions by communicating with the signal converter via the computer's USB connection and second electrical cord, such that the signal converter translates electrical queries from the computer's USB protocol to the appropriate OMB-II protocol for the vehicle, receives back the requested sensor readings, and compares them to operational standards that the computer obtains from a remote database and storage that is Internet-accessible.

2) The apparatus in claim 1, such that the first connector meets the SAE J1962 standard for a diagnostic connection;

3) The apparatus as in claim 1, such that the second connector is a micro-USB;

4) The apparatus in claim 1, such that the presence of a vehicle connected to the first diagnostic connection triggers a reading of the vehicle's VIN by the system and automatically accesses and stores the proper operational standards from the remote database.

5) The apparatus in claim 1, except that the signal converter is powered by the vehicle's diagnostic voltage bus.l

6) The apparatus in claim 1, with the additional feature that the computer application can download and store the proper operating parameters and diagnostic code information when a user installs or runs the program before the computer is attached to the signal converter.

7) The apparatus in claim 1, with the additional feature that the software application includes an optional help feature, assisting a user to find parts or installation help on the Internet.

8) A method to diagnose vehicle problems, including:
a. registering a user and his vehicles with a remote database located on a website and accessible by Internet;
b. downloading an application to an Internet-connected computer equipped with a USB port and capable of processing third-party programs;
c. running the downloaded application on the computer;
d. connecting a signal converter between the USB port on the computer and an on-board vehicle diagnostic connector, such that the signal converter converts instructions received from the computer through the USB port into communications compliant with the connected vehicle's diagnostic system while it is running the downloaded application, such that the computer can download the vehicle diagnostic fault codes from the vehicle; and,
e. accessing the remote database or other Internet resources to determine proper corrective actions to alleviate vehicle fault conditions, including potential sources for repair parts.

9) The method of claim 8 to diagnose vehicle problems, in which the computer is a cell phone.

10) The method of claim 8 to diagnose vehicle problems, in is which the computer is a laptop.

11) The method of claim 8 to diagnose vehicle problems, in which the computer is a desktop computer.

12) The method of claim 8 to diagnose vehicle problems, in which the remote database is defined to be stored data previously obtained and maintained on the computer.
